(19) United States
(12) Patent Application Publication
(10) Pub. No.: US 2015/0198282 A1
(43) Pub. Date: Jul. 16, 2015

(54) Portable Adjustable Storage Apparatus

(71) Applicant: Dianne Elizabeth Collentine, New Milford, CT (US)

(72) Inventor: Dianne Elizabeth Collentine, New Milford, CT (US)

(21) Appl. No.: 14/551,034

(22) Filed: Nov. 23, 2014

Related U.S. Application Data
(60) Provisional application No. 61/908,084, filed on Nov. 23, 2013.
(60) Provisional application No. 61/908,144, filed on Nov. 24, 2013.

(51) Int. Cl. F16M 13/02; F16B 47/00; A47G 35/00; F16B 45/00

(52) U.S. Cl. CPC F16M 13/02; F16B 45/00; F16B 47/00; A47G 35/00

(57) ABSTRACT

Storage assemblies are disclosed for storing small, frequently and repeatedly used objects such as shaving razors and eye glasses. The storage assemblies of the invention may be adjustable, portable, decorative, adorning and fun to use.

### FIELD OF THE INVENTION

The present invention relates to storage assemblies, more particularly to portable, adjustable and hanging storage assemblies for frequently and repeatedly used objects.

### BACKGROUND OF THE INVENTION

Throughout a week or day there are numerous objects that people use frequently and repeatedly. Many of the objects, when not in use are stored. Because the objects are used repeatedly, they are stored in a way that allows for ready access to the object for its next use. One purpose for storing the object is to extend or preserve its value. Another is to make the object readily accessible for its next use and another is to store the object safely and out of harm's way. Eyeglasses and shaving razors are two such objects that are used frequently and repeatedly and that when not in use are stored to extend and/or preserve the object's value and/or to store the object out of harm's way.

Shaving razors are typically portable and may be of a disposable type. When not in use the razor may be stored in numerous locations. Frequently, the razor is stored on a moist or even soapy surface in a flat conformation such that blades of the razor are close to and/or in contact with the surface. When this occurs, the razors effectiveness is often compromised by the moist or soapy environment.

Shaving razors which incorporate sharp blades are used to remove body hair. If not used properly, the razor's blade can inadvertently cut through skin. Many cuts caused by razor blades can be serious and often require medical treatment.

Accordingly, it would be an advance in the art to provide a portable, storage assembly that not only securely stores shaving razors, but that also stores shaving razors out of harm's way.

People wear eyeglasses for numerous uses. Often the reason is to assist or correct a wearer's vision. Often however, the use is intermittent and the need for the eyeglasses may depend on the particular task at hand. Generally, people who wear eyeglasses remove and replace them frequently during the course of a day, keeping the eyeglasses readily accessible for the next use. When an eyeglass wearer removes his or her eyeglasses, it is usually desired to keep the eyeglasses close at hand in order to be able to replace them conveniently. Upon removing eyeglasses, therefore, eyeglass wearers frequently place the eyeglasses on his or her head, in a pocket of a shirt or coat, or hang the eyeglasses from a neck opening of a sweater or a blouse. However, eyeglasses are often expensive and a necessity and a wearer's head, shirt pockets and/or neck openings in a garment may not be a secure location for storing the eyeglasses.

Some eyeglass wearers use retainers to suspend the eyeglasses about their neck when the eyeglasses are not being used. Conventional eyeglass retainers are simple one-piece bands which tie or slide onto the temple arms of the eyeglasses. These conventional eyeglass retainers are limited to a single use in that they serve no other purpose except to retain eye glasses about a wearer's neck. Additionally, conventional eyeglass retainers are not decorative and thus at best do not add to, and likely detract from, the aesthetic appearance of the wearer.

Accordingly, it would be an advance in the art to provide a portable, storage assembly that not only securely stores eyeglasses but that is also adjustable to accommodate multiple uses and that is easily accessible and decorative and that requires no assembly.

### SUMMARY OF THE INVENTION

In one aspect the invention provides a portable, adjustable, storage assembly, comprising a band, the band having a length, a first end and a second end, the band comprising along its length at least a first joining member and a second joining member where the at least first and second joining members are adapted for reversibly coupling.

In a further aspect the invention provides a portable, adjustable, storage assembly, comprising a flexible band, the flexible band having a length, a first end and a second end, the flexible band further comprising along its length at least a first joining member and a second joining member where the at least first and second joining members are adapted for reversibly coupling.

In a further aspect the invention provides a portable adjustable storage assembly comprising a band, the band having a length, a first end and a second end, the band comprising along its length at least a first joining member and a second joining member where the at least first and second joining members are adapted for reversibly coupling and wherein the first end and the second end are connected to form a necklace.

In a further aspect the invention provides a portable, adjustable, storage assembly, comprising a band, the band having a length, a first end and a second end, the band, further comprising along its length at least a first joining member and a second joining member where the at least first and second joining members are adapted for reversibly coupling and wherein the band further comprises at least one decoration.

In a further aspect the invention provides a portable, adjustable, storage assembly, comprising a band, the band having a length, a first end and a second end, the band comprising along its length at least a first joining member and a second joining member where the at least first and second joining members are reversibly coupled to form a joined member and a storage ring and wherein the storage ring is adapted for hanging and storing objects.

In a further aspect the invention provides a portable, storage assembly, comprising a band, the band having a length, a first end coupled to a hanging device and a second end coupled to a hanging device, wherein the band comprises at least one adornment along its length.

In a further aspect the invention provides a portable, storage assembly, comprising a band, the band having a length, a first end and a second end, a hanging device coupled to the first end and the second end, wherein the band comprises at least one adornment along its length.

In a further aspect the invention provides a portable, adjustable, storage assembly, comprising a band, the band having a length, a first end and a second end, wherein the first and second ends are coupled to form a necklace and wherein the band comprises at least one adornment along its length.

In another aspect the invention provides a method of using a portable, adjustable, storage assembly, comprising a band having a length, a first end, a second end, a first joining member along the length of the band and a second joining member along the length of the band, the method comprising hanging the first end, hanging the second end and coupling the first joining member to the second joining member to form a joined member and a storage member and storing an object in the storage member by hanging. Preferably the coupling of the first joining portion to the second joining portion is reversible and the joining forms a storage ring for hanging an object to be stored.

In another aspect the invention provides a method of using a portable, adjustable, storage assembly, comprising a band having a length, a first end, a second end, a first joining member along the length of the band and a second joining member along the length of the band and wherein the first joining member and the second joining member are adapted for hanging, the method comprising hanging the first end and the second end to form an elongated band, coupling the first joining member to the second joining member to form a joined member and a storage member and storing an object in the storage member by hanging. Preferably the coupling of the first joining portion to the second joining portion forms a storage ring and the coupling is reversible.

In another aspect the invention provides a method of using a portable, storage assembly, comprising a band having a length, a first end coupled to a first hanging device, a second end coupled to a second hanging device, and at least one adornment along the length of the band, the method comprising hanging the first and second hanging devices to form an elongated loop, the loop having an upper end and a lower end, wherein the lower end of the loop has a diameter of from about 0.5 inches to about 2 inches; and storing an object in the lower end of the loop by hanging.

In another aspect the invention provides a method of using a portable, storage assembly, comprising a band having a length, a first end coupled to a hanging device, a second end coupled to a hanging device, and at least one adornment along the length of the band, the method comprising hanging the first end and the second end to form an elongated loop having an upper end and a lower end, wherein the lower end of the loop has a diameter of from about 0.5 inches to about 2 inches and storing an object in the lower end of the loop by hanging.

In another aspect the invention provides a method of using a portable, storage assembly, comprising a band having a length, at least one adornment along the length of the band and a first end coupled to a second end to form a necklace, the method comprising hanging the necklace to form an elongated loop, the loop having an upper end and a lower end, wherein the lower end of the loop has a diameter of from about 0.5 inches to about 2 inches; and storing an object in the storage member by hanging.

In a still further aspect the invention provides a method of manufacturing a portable adjustable storage assembly comprising a band having a length, a first end, a second end, a first joining member along the length of the band and a second joining member along the length of the band, the method of manufacturing comprising coupling to the band at least a first joining member and a second joining member, where the first joining member and the second joining member are adapted for reversibly coupling.

### BRIEF DESCRIPTION OF THE DRAWINGS

FIG. 1 is a schematic illustration of the portable, adjustable, storage apparatus showing a first embodiment of the invention having first and second joining members.

FIG. 2 is a schematic illustration of the portable, adjustable, storage apparatus showing a further embodiment of the invention adapted for hanging.

FIG. 3 is a schematic illustration of the portable, adjustable, storage apparatus showing a further embodiment of the invention having joined first and second joining members.

FIG. 4 is a schematic illustration of the portable, adjustable, storage apparatus showing a further embodiment of the invention having ends adapted for hanging.

FIG. 5A and FIG. 5B show a schematic illustration of the portable, adjustable, storage apparatus showing a further embodiment of the invention, where the apparatus is hanging.

FIG. 6 is a schematic illustration of the portable, adjustable, storage apparatus showing a further embodiment of the invention.

FIG. 7A, FIG. 7B and FIG. 7C show a schematic illustration of the portable, adjustable, storage apparatus showing a further embodiment of the invention in the form of a necklace.

FIG. 8A, FIG. 8B, FIG. 8C and FIG. 8D show a schematic illustration of the portable, adjustable, storage apparatus showing a further embodiment of the invention having multiple joining members.

FIG. 9 is a schematic illustration of the portable, adjustable, storage apparatus showing a further embodiment of the invention having multiple joining members.

### DETAILED DESCRIPTION OF THE INVENTION AND PREFERRED EMBODIMENTS THEREOF

Reference throughout this specification to “one embodiment” or “an embodiment” means that a particular feature, structure, material, or characteristic described in connection with the embodiment is included in at least one embodiment of the invention, but do not denote that they are present in every embodiment. Thus, the appearances of the phrases “in one embodiment” or “in an embodiment” in various places throughout this specification are not necessarily referring to the same embodiment of the invention. Furthermore, the particular features, structures, materials, or characteristics may be combined in any suitable manner in one or more embodiments. Various additional layers and/or structures may be included and/or described features may be omitted in other embodiments.

It is noted that as used herein and in the appended claims, the singular forms “a”, “and”, and “the” include plural referents unless the context clearly dictates otherwise.

As will be appreciated by someone who is skilled in the art, after reading this specification in its entirety, the portable, adjustable, storage apparatus of the present invention not only functions as a storage apparatus, but the portable, adjustable, storage apparatus as described herein can also be decorative, adorning and fun to use.

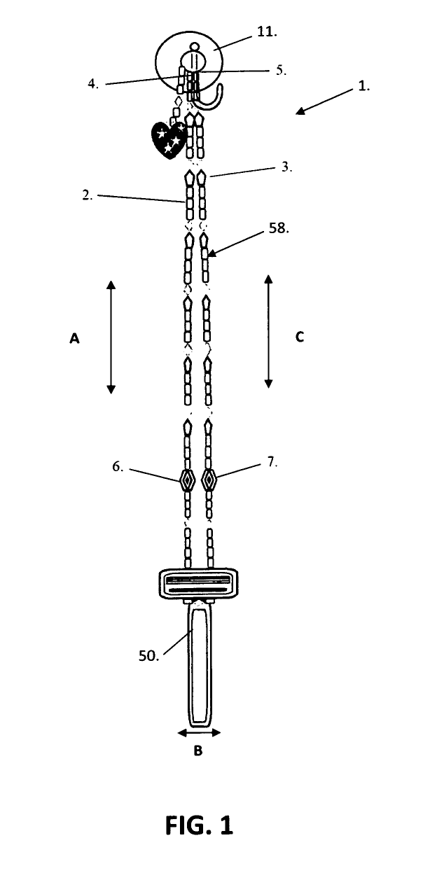

WITH REFERENCE TO THE DRAWINGS, the invention will now be described in detail with regard for the best mode and the preferred embodiments. FIG. 1 schematically illustrates a portable, adjustable, storage assembly 1, according to a first embodiment, the assembly comprising a band 2, the band having a length 3 (A+B+C), a first end 4, and a second end 5, the band comprising along its length at least a first joining member 6 and a second joining member 7, where the at least first and second joining members are adapted for coupling.

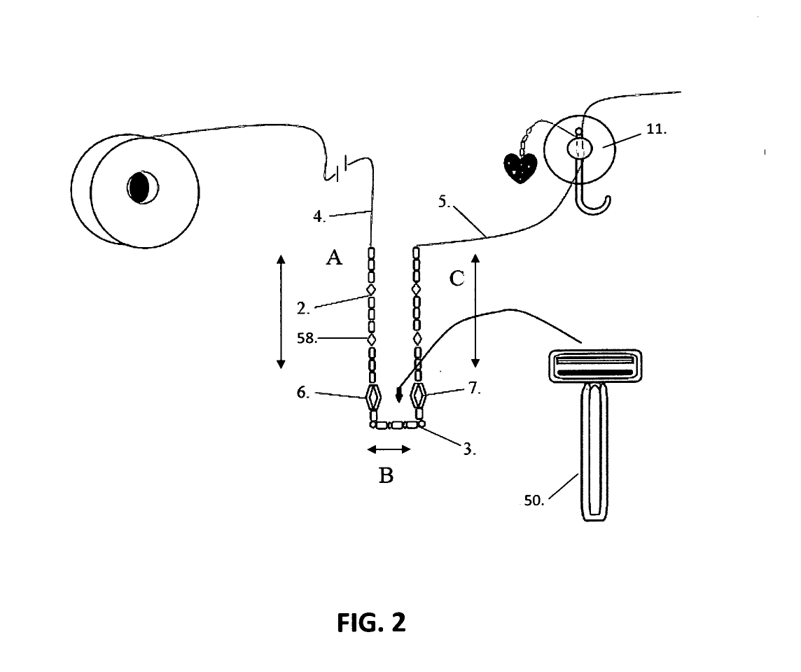

FIG. 2 schematically shows the portable, adjustable, storage system of FIG. 1 according to a further embodiment of the invention, the assembly comprising a band 2, the band having a length 3 (A+B+C) a first end 4, and a second end 5, the band comprising along its length at least a first joining member 6 and a second joining member 7, where the at least first and second joining members are adapted for coupling and the band is adapted for hanging with hanging device 11 (e.g. suction cup).

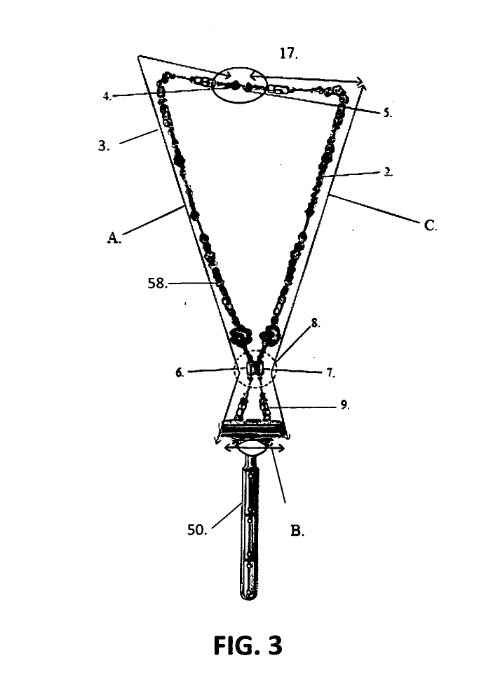

FIG. 3 schematically shows the portable, adjustable, storage apparatus of FIG. 1 according to a further embodiment, comprising a band 2, the band having a length 3 (A+B+C), a first end 4, and a second end 5, the band comprising along its length at least a first joining member 6 and a second joining member 7, wherein the at least first and second joining members are coupled to form a joined member (shown by dotted line) 8 and a storage ring 9.

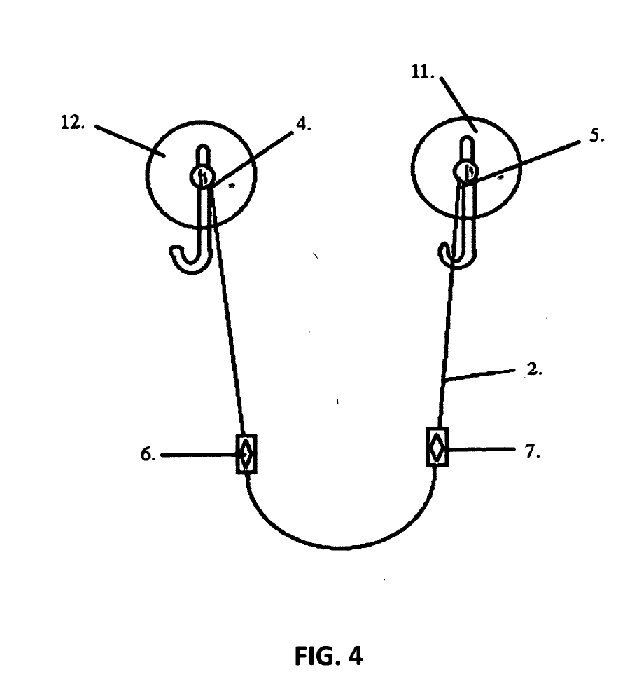

The portable, adjustable, storage apparatus of the present invention is preferably adapted for hanging. FIG. 4 is a schematic of one embodiment of the present invention where the portable, adjustable, storage apparatus of FIG. 1 is shown hanging from each of the first end 4 and the second end 5 of band 2 by hanging devices 11 and 12 (e.g. suction cups) wherein the hanging device 11 is coupled to the first end 4 of band 2 and the hanging device 12 is coupled to the second end 5 of band 2, the band further comprising along its length at least a first joining member 6 and a second joining member 7, wherein the at least first and second joining members are adapted for reversibly coupling. As shown in FIG. 4, hanging devices 11 and 12 can be the same. Alternatively, hanging devices 11 and 12 may be different.

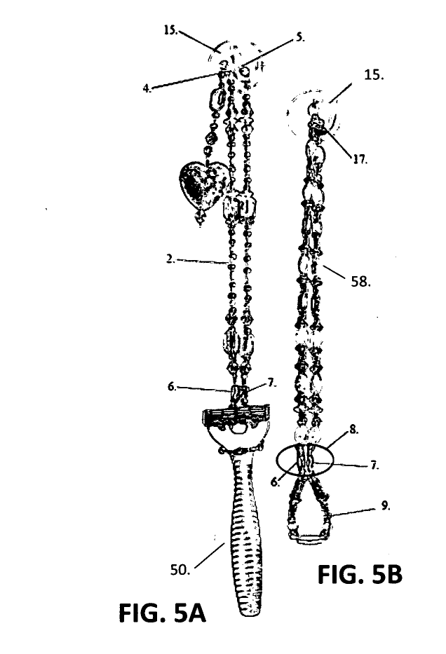

FIG. 5A is a schematic of a further embodiment of the invention where the portable, adjustable, storage apparatus of FIG. 1 is shown hanging from each of the first end 4 and the second end 5 of band 2 by a single suction cup 15. In this particular embodiment, the first end 4 and the second end 5 of band 2 may be joined to form a unitary band or loop 17 as shown in FIG. 5B where the unitary band 17 is coupled to suction cup 15. The unitary band 17 may be formed by joining first end 4 and second end 5 of band 2 before or after coupling to the suction cup 15, the band as shown in FIG. 5A and FIG. 5B further comprising along its length at least a first joining member 6 and a second joining member 7, wherein the at least first and second joining members are adapted for reversibly coupling.

In one embodiment, the first and second ends may be fastened together to form a unitary band as shown schematically in FIG. 5B or the first and second ends may comprise one end each of a clasping device that mates and un-mates respectively for clasping and unclasping the first and second ends (not shown). Clasping devices useful in the present invention are readily ascertained by one skilled in the art and include but are not limited to spring clips, hook eye, lobster claw, jump rings, spring connectors, spring ring, circle and bar, toggle, fold over, fish hook, s-hook, barrel, spring, box clasp, multi-strand clasp, ball and chain clasp, slide lock, tube bar clasp or pin clasp, ribbon, bead on bead, screw clasp and lanyard spring hook clasp. In a further embodiment, the band may comprise additional receiving ends of clasping devices in order to readily change the length of the band by fastening the clasping end of the band to various receiving ends at various locations along the length of the band.

FIG. 5B further shows the portable, adjustable storage apparatus of the present invention, comprising band 2, having a length, a first end 4, and a second end 5, the band comprising along its length at least a first joining member 6 and a second joining member 7, wherein the at least first and second joining members are coupled to form a joined member 8 and a storage ring 9 where the band of the portable, adjustable storage apparatus hangs when in use and the storage ring stores an object by at least one of hanging, supporting and coupling.

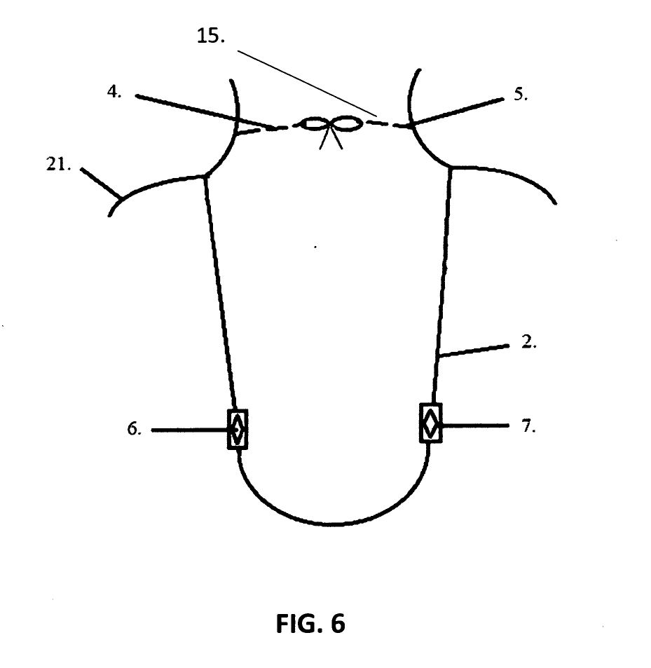

FIG. 6 is a schematic of a further embodiment of the invention where the portable, adjustable, storage apparatus of FIG. 1 is shown hanging around an object 21. In this particular embodiment, the first end 4 and the second end 5 of band 2 are joined to form a necklace (shown by dotted line) 23. The first end 4 and the second end 5 may be adapted for reversibly closing such as by use of a clasp or the first end 4 and second end 5 are joined without the use of a closure or clasp, the band further comprising along its length at least a first joining member 6 and a second joining member 7, wherein the at least first and second joining members are adapted for reversibly coupling.

The portable, adjustable, storage apparatus of the present invention comprises a band. The band may comprise a long thin strip of material which may be in the form of a loop or the long strip of material may comprise first and second ends that are joinable to form a loop. The band may be a single material and structure or a composite of materials and structures. The band may comprise a single strand or multiple strands and may be made using one or more components including but not limited to threads, yarns, ribbons, cords, chains, wires, cables, filaments, strings, ropes, bands, elastic and flexible versions and combinations of the foregoing. The band may comprise knots or may be wrapped several times around an object. The band may further comprise adornments including but not limited to chains, jewels, charms, trinkets, crystals, minerals, beads, rings, pendants, medallions, baubles, bangles, lockets, shells, gems, gemstones, corals, ribbons, advertisements, and combinations of the foregoing. The band may be made using any material including but not limited to cellulose, natural and synthetic resins, rubber and other plastics, metals, metal alloys, metal veneer, ceramics, glass, crystals, minerals, jewels and combinations of the foregoing. Further the bands may be manufactured using methods known to those skilled in the art, including but not limited to threading, beading, crocheting, knitting, stringing, stamping, molding, cutting, linking, crimping, tying, weaving, welding, gluing and combinations of the foregoing. The band may be flexible or elastic along its entire length or the band may be flexible or elastic along one or more portions of its length. In a preferred embodiment, the band comprises a string of beads, wherein the string is elastic or flexible.

In a further embodiment, the portable, adjustable, storage apparatus of the present invention comprises a band having a length between 4 inches and 60 inches. However, longer bands may be preferable where the portable, adjustable, storage apparatus comprises multiple storage rings or where the intended use comprises draping the band several times around an object such as a lariat style necklace. Preferably, the portable, adjustable, storage apparatus comprises a band having a length of from 20 inches to 32 inches.

As used herein, the terms loop and necklace are equivalent and interchangeable. In a further embodiment, the portable, adjustable, storage apparatus comprises a continuous band which is formed into a loop or necklace. The loop or necklace may hang from or around objects without the need for ancillary hanging devices such as hooks and/or suction cups. Accordingly in another embodiment, the portable, adjustable, storage assembly of the invention comprises a band, the band having a length, a first end and a second end, the band comprising along its length at least a first joining member and a second joining member where the at least first and second joining members are adapted for coupling and wherein the first end and the second end are connected to form a continuous loop or necklace. The necklaces of the invention can be worn around necks e.g. necklaces, wrists, e.g. anklets, ankles, e.g. anklets, waist, e.g. waist chains, and other body parts as well as hung from or around readily accessible objects such as purses, purse straps, belt loops, lampshades, car mirrors and bed posts. Preferably the first joining member is joined to the second joining member to form a joined member and a storage ring.

In a further embodiment, the portable, adjustable, storage apparatus comprises a band, the band having a length, a first end, and a second end, the band comprising along its length at least a first joining member and a second joining member, wherein the at least first and second joining members are coupled to form a joined member and a storage ring. Preferably the first and second joining members are positioned on the band such that when the first joining member couples to the second joining member to form the joined member, the storage ring comprises a diameter or width in the range of from 0.5 to 2.0 inches, with a diameter or width of about 1.0 inch being particularly preferred. Although referred to herein as a storage ring, the structure formed by coupling the joining members and used to store, support or couple to the object being stored, may take on any shape or size as will be appreciated by those skilled in the art. Although not wishing to be limited to same, the various figures referenced throughout this application, illustrate various shapes and sizes of storage rings formed by coupling first joining members to second joining members.

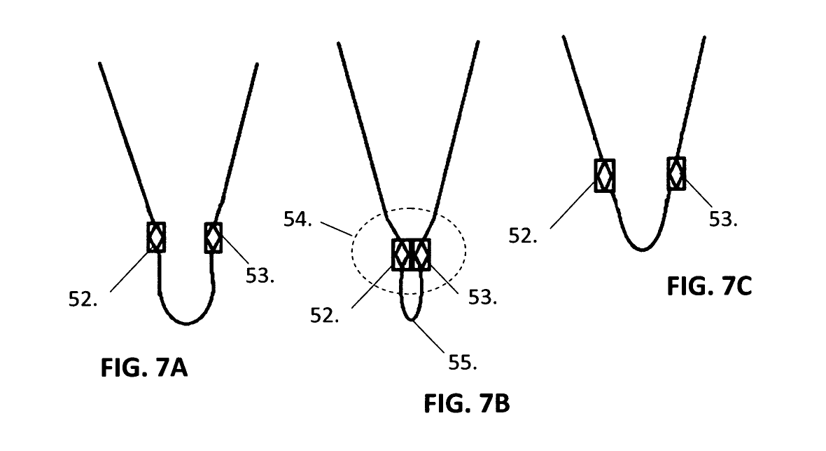

FIGS. 7A-7C schematically show one embodiment of the portable, adjustable, storage apparatus of the invention comprising an at least first joining member 52 and a second joining member 53 in a pre-coupled or pre-joined state (FIG. 7A), a joined or coupled state (FIG. 7B) and an uncoupled or un-joined state (FIG. 7C). Although not wishing to be limited to same, the joining members 52 and 53 shown in FIGS. 7A-7C comprise magnetically active beads. FIG. 7A shows first joining member 52 and second joining member 53 in coupling proximity. FIG. 7B shows joining members 52 and 53 coupled together to form a joined member 54 and FIG. 7C shows first joining member 52 and second joining member 53 uncoupled or un-joined. The magnetically active joining member 52 is magnetically attracted to the second joining member 53 such that when the magnetic joining member 52 is brought into coupling proximity to the second joining member 53, the first magnetically active joining member magnetically couples to the second joining member to form the joined member 54, and a storage ring 55, as shown in FIG. 7B. One advantage of the present invention is that once the joined member 54 is formed, the joined member can be released or separated back into its original form as shown in FIG. 7C.

The joining members used in the present invention can be readily ascertained by one skilled in the art and may include mechanical and non-mechanical assemblies that are used to reversibly couple, fasten or join two objects together. Joining members useful in the present invention include but are not limited to non-mechanical magnetic assemblies and mechanical magnetic assemblies. Non-mechanical and mechanical magnetic assemblies useful in the present invention include but are not limited to rare earth and hematite magnets. Other mechanical assemblies useful in the present invention include but are not limited to ferrule and bore, spring clips, hook eye, lobster claw, jump ring, spring connector, spring ring, circle and bar, toggle, fold over, fish hook, s-hook, barrel, spring, box clasp, multi-strand clasp, ball and chain clasp, slide ‘Z’, ‘E’ and ‘D’ closures, infinity link, slip knot, sliding knot, tying, knotting, button clasp, hook eye, lobster claw, jump rings, spring connectors, spring ring, circle and bar, toggle, fold over, fish hook, S-hook, barrel, spring, box clasp, multi-strand clasp, ball and chain clasp, slide lock, tube bar clasp or pin clasp, ribbon, bead on bead, screw clasp, wire, stretch string and lanyard spring hook clasp. The joining members may be of any shape or size and may be made using any suitable material. Suitable shapes, sizes and materials of construction are readily determinable by one skilled in the art. The joining members may be incorporated into a band during manufacture by methods know to one skilled in the art or the joining members may be attached to the band after manufacturing. Useful methods for incorporating or attaching the joining members to the band include but are not limited to threading, beading, crocheting, knitting, stringing, stamping, molding, cutting, linking, crimping, tying, weaving, welding, gluing and combinations of the foregoing. Preferably, the first joining member and the second joining member are positioned along the band by a distance of from about 2 inches to about 6 inches, such that when the first joining member is coupled to the second joining member to form a joined member and a storage ring, the storage ring comprises a diameter of from about 0.5 inches to about 2 inches.

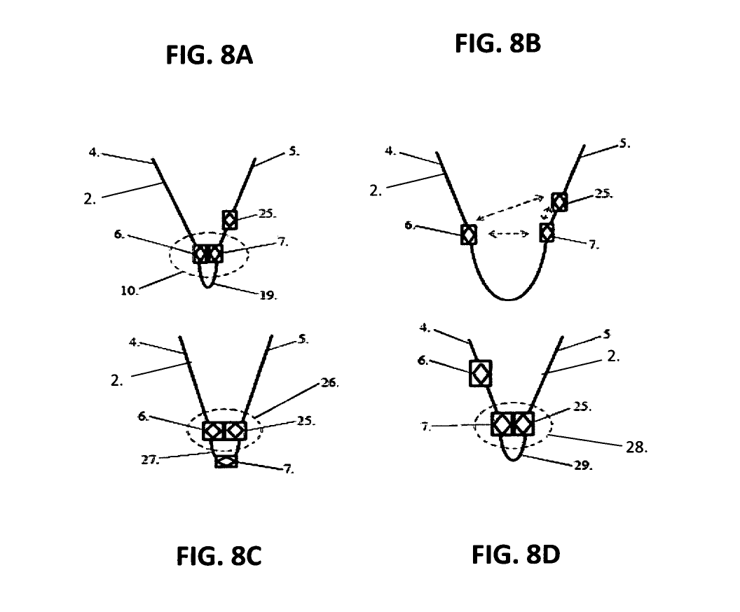

FIG. 8A schematically shows a further embodiment of the portable, adjustable storage apparatus of the present invention, comprising a band 2, the band, having a first end 4, and a second end 5, the band comprising along its length, a first joining member 6, a second joining member 7, and a third joining member 25, wherein the first, second and third joining members are adapted for interchangeably and reversibly coupling to form at least one joined member 10 (shown by dotted lines) and a storage ring 19. FIG. 8B further shows by dotted lines where the first, second and third joining members 6, 7 and 25 respectively may be interchanged and joined according to the relationships shown in the following Table where the number in the Table corresponds to the member in each respective figure.

| Joining | May couples to | To form joined | And Storage | Shown in |
|---|---|---|---|---|
| Member | Joining Member | Member | Ring | FIG. |
| 6 | 7 | 10 | 19 | 8A |
| 6 | 25 | 26 | 27 | 8C |
| 7 | 25 | 28 | 29 | 8D |

Preferably, joining members 6, 7 and 25 are positioned along the band by a distance of from about 2 inches to about 6 inches, such that when any one of joining members 6, 7 and 25 reversibly couples to one of the remaining two joining members to form a joined member and a storage ring, the storage ring comprises a diameter of from about 0.5 inches to about 2 inches. The portable, adjustable, storage apparatus may further comprise additional joining members along the length of the band for reversibly coupling to at least one other joining member. By providing a band having three or more joining members that can be reversibly coupled to form multiple joined members, multiple storage rings and/or storage rings of varying sizes, the portable, adjustable, storage apparatus of the present invention is adjustable.

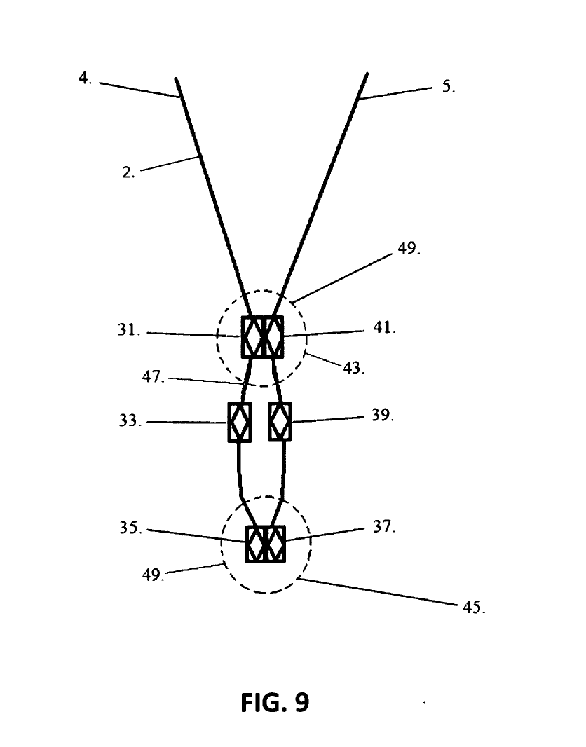

FIG. 9 schematically shows a further embodiment of the portable, adjustable storage apparatus of the present invention comprising a band 2, a first end 4, and a second end 5, the band comprising along its length, six joining members 31, 33, 35, 37, 39 and 41 adapted for interchangeably and reversibly coupling to form at least two joined members 43 and 45 (shown by dotted lines) and at least two storage rings 47 and 49 respectively. Preferably, joining members 31, 33, 35, 37, 39 and 41 are positioned along the band and separated from the next joining member by a distance of from about 2 inches to about 6 inches, such that when any one of joining members 31, 33, 35, 37, 39 and 41 reversibly couples to one of the other joining members to form a joined member and a storage ring, the storage ring comprises a diameter of from about 0.5 inches to about 2 inches. By providing a band having four or more joining members that can be reversibly coupled to form multiple joined members, multiple storage rings and/or storage rings of varying sizes, the portable, adjustable, storage apparatus of the present invention is adjustable.

A still further embodiment of the portable, adjustable storage apparatus of the present invention comprises a band, the band having a length, a first end, and a second end, the band comprising along its length at least a first joining member and a second joining member, wherein the first joining member and the second joining member are adapted for reversibly coupling to form a joined member and a storage ring and wherein at least one of the first joining member and the second joining member is adapted for repositioning along the band to a new location by moving. Preferably, a joining member is repositioned along the band by sliding. Preferably, the at least first and second joining members are positioned or repositioned along the band and separated from one another by a distance of from about 2 inches to about 6 inches, such that when the first and second joining members couple to form a joined member and a storage ring, the storage ring comprises a diameter of from about 0.5 inches to about 2 inches. Although the present embodiment is described as comprising at least one movable joining member, the portable, adjustable, storage apparatus of the present invention is not limited to such and may further comprise multiple movable joining members that may be coupled to form one or more storage rings of one or more diameters or along one or more locations of the band. Movable and/or slidable, joining members include buckles, slip knots and slide knots. By providing a band having at least one movable joining member that can couple to a second joining member to form a joined member and storage rings at different locations along the band and having different diameters, the portable, adjustable, storage apparatus of the present invention is adjustable.

The foregoing embodiments may comprise all of the various elements described herein and may be manufactured and used accordingly. Although not wishing to be limited to same, the portable, adjustable, storage apparatus of the invention may be used to store and/or hang small objects including but not limited to eyeglasses, pens, pencils, keys, portable memory sticks, ornaments, hair clips, baby toys, small tools, advertisements, small food objects, name tags and other forms of identification, toothbrushes and shaving razors.

In a preferred embodiment of the portable, adjustable, storage apparatus of the invention the first end and the second end are connected to form a necklace. The first and second joining members are coupled to form a joined member and a storage ring, where the storage ring has a preferred diameter of between 0.5 inches and 1.5 inches; the band is a necklace and comprises a length of from about 12 inches to 24 inches and the necklace comprises a flexible material and at least one decoration; and the necklace is worn about a neck. Preferably, the storage ring receives an object to be stored including but not limited to eyeglasses, pens, pencils, keys, portable memory sticks, ornaments, hair clips, baby toys, small tools etc. In a preferred embodiment, the storage ring receives a pair of eyeglasses, e.g. a temple piece of a pair of eyeglasses. The eyeglasses may be folded in a closed configuration.

In a further preferred embodiment, the adjustable, storage apparatus of the invention comprising a band, where the band may be hung from a hanging device or on or around an object. Preferably, the storage ring receives an object to be stored including but not limited to eyeglasses, pens, pencils, keys, portable memory sticks, ornaments, hair clips, baby toys, shaving razors and small tools etc. In a preferred embodiment, the storage ring receives a shaving razor, having a long handle and a generally rectangular head mounted on one end of the handle by inserting the handle through the storage ring and resting the rectangular head thereon.

In a further embodiment, the invention is directed to a method of storing an object comprising hanging a band, the band having a length, a first end and a second end, the band comprising along its length at least a first joining member and a second joining member where the at least first and second joining members are adapted for coupling and wherein the first end and the second end are connected to form a necklace; the method comprising joining the first joining member and the second joining member to form a joined member and a storage ring, and hanging an object selected from the group consisting of eyeglasses, pens, pencils, keys, portable memory sticks, ornaments, hair clips, baby toys and small tools from the storage ring.

FIG. 5A shows a schematic of a further preferred embodiment of the portable, adjustable, storage apparatus of the invention comprising a band 2, the band having a length, a first end 4, and a second end 5, the band comprising along its length at least a first joining member 6, and a second joining member 7, where the at least first and second joining members are adapted for reversibly coupling and wherein the first end and the second end are adapted for hanging 15. Preferably, the first and second joining members are coupled to form a joined member 8, and a storage ring 9, where the storage ring has a diameter of between 0.5 inches and 1.5 inches; the band comprising a flexible or elastic strand and a length of from about 12 inches to 24 inches and at least one decoration. Preferably, the storage ring receives an object to be stored including but not limited to eyeglasses, pens, pencils, keys, portable memory sticks, ornaments, hair clips, baby toys, small tools and shaving razors. In a preferred embodiment, the storage ring receives a shaving razor 50 having a long handle and a generally rectangular head mounted on one end of the handle by inserting the handle through the storage ring and resting the rectangular head on the storage ring.

In a further embodiment, the invention is directed to a method of using a portable, adjustable, storage apparatus, the portable, adjustable, storage apparatus comprising, a band, the band having a length, a first end, a second end, a first joining member and a second joining member where the at least first and second joining members are adapted for reversibly coupling and wherein the first end and the second end are adapted for hanging; the method comprising hanging the first end and the second end to form an elongated band, coupling the first joining member and the second joining member to form a joined member and a storage ring, and hanging an object selected from the group consisting of eyeglasses, pens, pencils, keys, portable memory sticks, ornaments, hair clips, baby toys, shaving razors and small tools from the storage ring.

Although described herein as comprising joining members, in alternative embodiments the portable, storage assembly, may be made and used without joining members. More specifically, the portable, storage assembly comprising a band having a length, a first end and a second end and at least one adornment along the length of the band, may be configured where the first and second ends are coupled to first and second hanging devices; the first and second ends are coupled to a single hanging device; or the first and second ends are coupled together to form a necklace. By hanging the two hanging devices within less than two inches of each other; by hanging the single hanging device; or by hanging the necklace from an object that is less than two inches in diameter, preferably less than one inch in diameter, such as the neck of a showerhead, the band will form an adorned and hanging elongated loop. FIG. 5A shows first 6 and second 7 joining members coupled together. However, the band comprising adornments can be made without joining members 6 and 7 and because of the close proximity of the two sides of the band; certain objects such as shaving razors can be stored in the lower end of the loop by hanging, where each end of the razors horizontal head rests on the band.

In another aspect the invention provides a method of using a portable, adjustable, storage assembly, comprising a band having a length, a first end, a second end, a first joining member along the length of the band and a second joining member along the length of the band, the method comprising hanging the first end, hanging the second end and coupling the first joining member to the second joining member to form a joined member and a storage member and storing an object in the storage member by hanging. Preferably the coupling of the first joining portion to the second joining portion is reversible and the joining forms a storage ring for hanging an object to be stored.

In another aspect the invention provides a method of using a portable, adjustable, storage assembly, comprising a band having a length, a first end, a second end, a first joining member along the length of the band and a second joining member along the length of the band and wherein the first joining member and the second joining member are adapted for hanging, the method comprising hanging the first end and the second end to form an elongated band, coupling the first joining member to the second joining member to form a joined member and a storage member and storing an object in the storage member by hanging. Preferably the coupling of the first joining portion to the second joining portion forms a storage ring and the coupling is reversible.

In another aspect the invention provides a method of using a portable, storage assembly, comprising a band having a length, a first end coupled to a first hanging device, a second end coupled to a second hanging device, and at least one adornment along the length of the band, the method comprising hanging the first and second hanging devices to form an elongated loop, the loop having an upper end and a lower end, wherein the lower end of the loop has a diameter of from about 0.5 inches to about 2 inches; and storing an object in the lower end of the loop by hanging.

In another aspect the invention provides a method of using a portable, storage assembly, comprising a band having a length, a first end coupled to a hanging device, a second end coupled to a hanging device, and at least one adornment along the length of the band, the method comprising hanging the first end and the second end to form an elongated loop having an upper end and a lower end, wherein the lower end of the loop has a diameter of from about 0.5 inches to about 2 inches and storing an object in the lower end of the loop by hanging.

In another aspect the invention provides a method of using a portable, storage assembly, comprising a band having a length, at least one adornment along the length of the band and a first end coupled to a second end to form a necklace, the method comprising hanging the necklace to form an elongated loop, the loop having an upper end and a lower end, wherein the lower end of the loop has a diameter of from about 0.5 inches to about 2 inches; and storing an object in the storage member by hanging.

The following examples are intended to show two embodiments of the invention and are intended in no way to be limiting.

### Example 1

Referring again to FIG. 2, to form a portable, adjustable, storage apparatus of the present invention, secure (tie off) first end 4 of a band 2, approximately 24 inches long; thread approximately 9 inches of beads 58, onto the band using the unsecured end 5; thread a magnetic bead (joining member) 6, onto the strand; thread approximately 6 more inches of beads onto the band 2; thread a second magnetic bead (joining member) 7, onto the band; thread an additional 9 inches of beads onto the band and; secure the second end. Thread the first and second ends through a hole in the suction cup 8. Referring now to FIG. 5, hang the band by attaching the suction cup 8 to a clean tile or glass surface. Join the first magnetic bead to the second magnetic bead to form joined member 8 and storage ring 9. Insert a shaving razor into the storage ring by inserting the long end through the ring and resting the horizontal shaving razor head on the ring.

### Example 2

Measure cord to desired length, string beads or other ornamental decorative items onto said cord. Add magnetic bead about 6 inches down, add another magnetic bead about two inches later, and continue until desired length is met. Tie the two ends in a secure knot; you may use closing devices if desired. You may hang it around your neck or onto other items, for example, suction cups, hooks, knobs.

Although this invention has been shown and described with respect to the detailed embodiments thereof, it will be understood by those skilled in the art, that various changes in form and detail thereof may be made without departing from the spirit, use, and scope of the invention.

What I claim is:

1. A portable, adjustable, storage assembly, comprising a band, the band having a length, a first end and a second end, the band further comprising along its length, at least a first joining member and a second joining member wherein the at least first and second joining members are adapted for reversibly coupling.

2. The portable, adjustable, storage assembly, according to claim 1 comprising a flexible band.

3. The portable adjustable storage assembly according to claim 1, wherein the first end and the second end are connected to form a necklace.

4. The portable adjustable storage assembly according to claim 1, wherein the band further comprises at least one decoration.

5. The portable adjustable storage assembly according to claim 1, wherein the at least first and second joining members are coupled to form a joined member and a storage ring and wherein the storage ring is adapted for hanging and storing objects.

6. The portable adjustable storage assembly according to claim 1, wherein the first end and the second end are coupled to a hanging device.

7. The portable adjustable storage assembly according to claim 6, wherein the hanging device is selected from the group consisting of suction cup and hook.

8. The portable adjustable storage assembly according to claim 1, wherein the assembly is portable.

9. The portable adjustable storage assembly according to claim 1, wherein the storage ring has a diameter of from about 0.5 inches to about 2 inches.

10. The portable adjustable storage assembly according to claim 1, wherein the first and second joining members are selected from the group consisting of mechanical and non-mechanical.

11. The portable adjustable storage assembly according to claim 1, wherein at least one of the first and second joining members is magnetic.

12. The portable adjustable storage assembly according to claim 11, wherein the magnetic joining member is selected from the group consisting of rare earth and hematite.

13. The portable adjustable storage assembly according to claim 1, wherein the first and second joining members comprise a mechanical assembly selected from the group consisting of ferrule and bore, spring clips, hook eye, lobster claw, jump ring, spring connector, spring ring, circle and bar, toggle, fold over, fish hook, s-hook, barrel, spring, box clasp, multi-strand clasp, ball and chain clasp, slide ‘Z’, ‘E’ and ‘D’ closures, infinity link, slip knot, sliding knot, tying, knotting, button clasp, hook eye, lobster claw, jump rings, spring connectors, spring ring, circle and bar, toggle, fold over, fish hook, S-hook, barrel, spring, box clasp, multi-strand clasp, ball and chain clasp, slide lock, tube bar clasp or pin clasp, ribbon, bead on bead, screw clasp, wire, stretch string and lanyard spring hook clasp.

14. The portable adjustable storage assembly according to claim 1, wherein the at least first and second joining members are coupled to form a joined member and a storage ring and wherein the storage ring is adapted for hanging and storing objects.

15. A method of using the assembly of claim 1, comprising coupling the first joining member to the second joining member to form a joined member and a storage member and storing an object in the storage member by hanging.

16. The method of claim 15 further comprising hanging the first end and the second end to form an elongated band.

17. A method of manufacturing a portable adjustable storage assembly comprising a band having a length, a first end, a second end, a first joining member along the length of the band and a second joining member along the length of the band, the method of manufacturing comprising coupling to the band at least a first joining member and a second joining member, where the first joining member and the second joining member are adapted for reversibly coupling.

18. The method of claim 17 further comprising coupling the first end and the second end to a hanging device.
